(19) United States
(12) Patent Application Publication
(10) Pub. No.: US 2022/0318703 A1
(43) Pub. Date: Oct. 6, 2022

(54) BUSINESS PROCESS MANAGEMENT SYSTEM AND BUSINESS PROCESS MANAGEMENT METHOD

(71) Applicants: DATA SYSTEMS CONSULTING CO., LTD., New Taipei City (TW); Digiwin Software Co., Ltd, Shanghai (CN)

(72) Inventors: Chu Yang WANG, New Taipei City (TW); Guoxin SUN, Shanghai (CN)

(73) Assignees: DATA SYSTEMS CONSULTING CO., LTD., New Taipei City (TW); Digiwin Software Co., Ltd, Shanghai (CN)

(21) Appl. No.: 17/329,186

(22) Filed: May 25, 2021

(30) Foreign Application Priority Data
Apr. 6, 2021 (TW) 110112392

(51) Int. Cl. G06Q 10/06

(52) U.S. Cl. CPC G06Q 10/0637; G06Q 10/067

(57) ABSTRACT

A business process management system and a business process management method are provided. The business process management system includes a process engine and a rerouting device. The process engine performs a flow processing of at least one piece of business data in units of forms according to multiple process gateways disposed in an original business process. The rerouting device is disposed in the original business process. When the at least one piece of business data is transmitted to the rerouting device, the rerouting device groups the at least one piece of business data to generate at least one business data group, and initiates at least one new business process. The original business process and the at least one new business process are respectively composed of the same multiple process gateways. The process engine distributes the at least one business data group to the at least one new business process.

### CROSS-REFERENCE TO RELATED APPLICATION

This application claims the priority benefit of Taiwanese application serial no. 110112392, filed on Apr. 6, 2021. The entirety of the above-mentioned patent application is hereby incorporated by reference herein and made a part of this specification.

### BACKGROUND

### Technical Field

The disclosure relates to a management system and a method thereof, and especially relates to a business process management system and a method thereof.

### Description of Related Art

Although most of the current business process management systems of enterprise business are different from the previous workflow systems, they are not limited to the completion of manual tasks, but can also string together non-manual tasks between systems to achieve a certain degree of automation. In this regard, the current business process management system uses a process engine to transmit business data to the post-position gateways one by one, and allows people or the system to process the intermediate state data that has been completed by the preposition gateways. However, as the business process processing may be implemented in different regions, different industries, or even the same company or different factories, even business processes of the same nature may have completely different business data flow processes. Due to the complexity of business scenarios and the possibility of large differences, when multiple business data need to be processed at the same gateway, it is not possible to move to the next gateway alone after any business data is processed, but has to wait for all business data in the same gateway to be processed before moving to the next gateway, resulting in the accumulation of time costs for waiting for business data to be processed. In view of this, solutions will be proposed in the following embodiments.

### SUMMARY

The disclosure provides a business process management system and a business process management method capable of providing high-efficiency and high-flexibility of business data flow.

The business process management system of the disclosure includes a process engine and a rerouting device. The process engine is configured to perform a flow processing of at least one piece of business data in units of forms according to multiple process gateways disposed in an original business process. The rerouting device is disposed in the original business process. When the at least one piece of business data is transmitted to the rerouting device, the rerouting device groups the at least one piece of business data to generate at least one business data group, and initiates at least one new business process. The original business process and the at least one new business process are respectively composed of the same process gateways. The process engine distributes the at least one business data group to the at least one new business process.

The business process management method of the disclosure includes the following. A flow processing of at least one piece of business data is performed in units of forms according to multiple process gateways disposed in an original business process. The at least one piece of business data is grouped through a rerouting device to generate the at least one business data group when the at least one piece of business data is transmitted to the rerouting device. At least one new business process is initiated through the rerouting device. The original business process and the at least one new business process are respectively composed of the same process gateways. The at least one business data group is distributed to the at least one new business process through the process engine.

Based on the above, the business process management system and the business process management method of the disclosure may group at least one business data to generate the at least one business data group through the rerouting device, and distribute the at least one business data group to a new business process to perform high-efficiency and high-flexibility of business data flow.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a business process management system according to an embodiment of the disclosure.

FIG. 2 is a flowchart of a business process management method according to an embodiment of the disclosure.

FIG. 3 is a schematic diagram of a rerouting device according to an embodiment of the disclosure.

FIG. 4 is a flowchart of a business process management method according to another embodiment of the disclosure.

FIG. 5 is a schematic diagram of a new business process according to an embodiment of the disclosure.

FIG. 6 is a schematic diagram of another new business process according to an embodiment of the disclosure.

FIG. 7 is a schematic diagram of an original business process according to an embodiment of the disclosure.

### DESCRIPTION OF THE EMBODIMENTS

In order to make the content of the disclosure easier to understand, the following examples are given as examples that the disclosure can indeed be implemented. In addition, wherever possible, elements/components/steps with the same reference numbers in the drawings and embodiments represent the same or similar components.

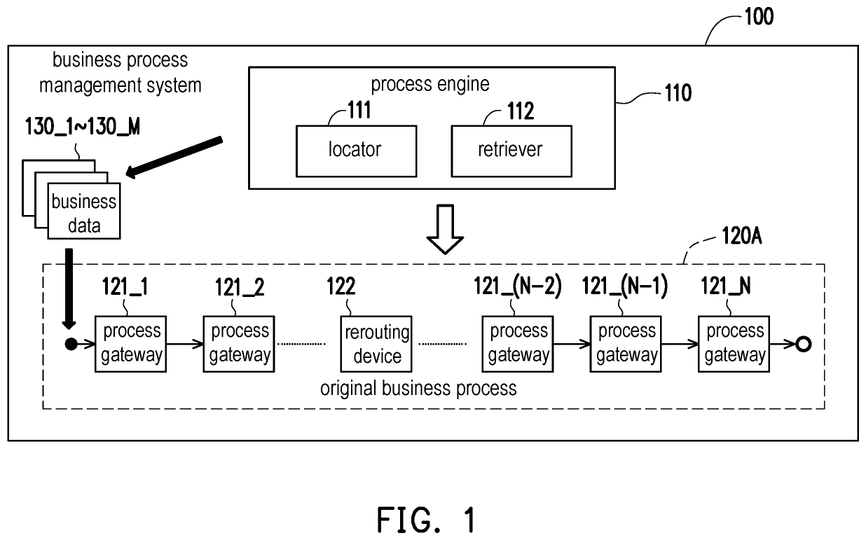

FIG. 1 is a schematic diagram of a business process management system according to an embodiment of the disclosure. Referring to FIG. 1, a business process management system 100 includes a process engine 110 and an original business process 120A. The process engine 110 includes a locator 111 and a retriever 112. The original business process 120A includes multiple process gateways 121_1 to 121_N and a rerouting device 122, where N is a positive integer greater than 1. In this embodiment, the process engine 110 performs a flow processing of at least one piece of business data 130_1 to 130_M in units of forms according to the process gateways 121_1 to 121_N in the original business process 120A, where M is a positive integer greater than 0. A piece of form may include at least one piece of the business data. In this embodiment, the business process management system 100 may dispose the rerouting device 122 in any two of the process gateways 121_1 to 121_N. In this regard, the business process management system 100 may first design the original business process 120A through settings of a process designer, and add the rerouting device 122 after the process gateways for expected distribution, and configure a business rerouting logic. However, the disclosure is not limited to the disposed position, the number of process gateways, and the process arrangement manner of the rerouting device 122 as shown in FIG. 1. The form of the original business process 120A shown in FIG. 1 is only an example.

In this embodiment, the business process management system 100 may be a business process infrastructure established based on business process model and notation method (BPMN), and the process engine 110 may be implemented based on BPMN specifications. In specific application embodiments, the business process management system 100 may be implemented by a host computer or a server host connected to (or communicating with) multiple computer hardware devices. The multiple computer hardware devices may include, for example, a personal computer (PC), a workstation computer, a mobile computer, a server computer, etc. The multiple process gateways 121_1 to 121_N in the original business process 120A may respectively represent business behaviors performed by the multiple computer hardware devices. The host computer, the server host, and the multiple computer hardware devices respectively include a processor and a memory to implement or perform business process management according to the embodiments of the disclosure, business behaviors, and to store relevant functions and operations of corresponding relevant business data.

Furthermore, the host computer or the server host may be disposed with software programs or modules for implementing the business process management. The multiple computer hardware devices may be equipped with relevant applications or business programs for performing business activities. The host computer, the server host, and the multiple computer hardware devices communicate with each other in a wired or wireless manner or are connected via a network to implement business process operation of the business process management system 100. It should be noted that the locator 111, the retriever112, and the rerouting device 122 according to this embodiment in the disclosure are further designed to be a functional software or module that may be performed in the business process management system 100, and may perform specific functions thereof through, for example, the host computer or the server host. In this regard, the business process management system 100 may implement the locator 111, the retriever112, and the rerouting device 122 to effectively improve business process efficiency, and may simultaneously take into account the original BPMN specifications and the implementation and operation of the workflow.

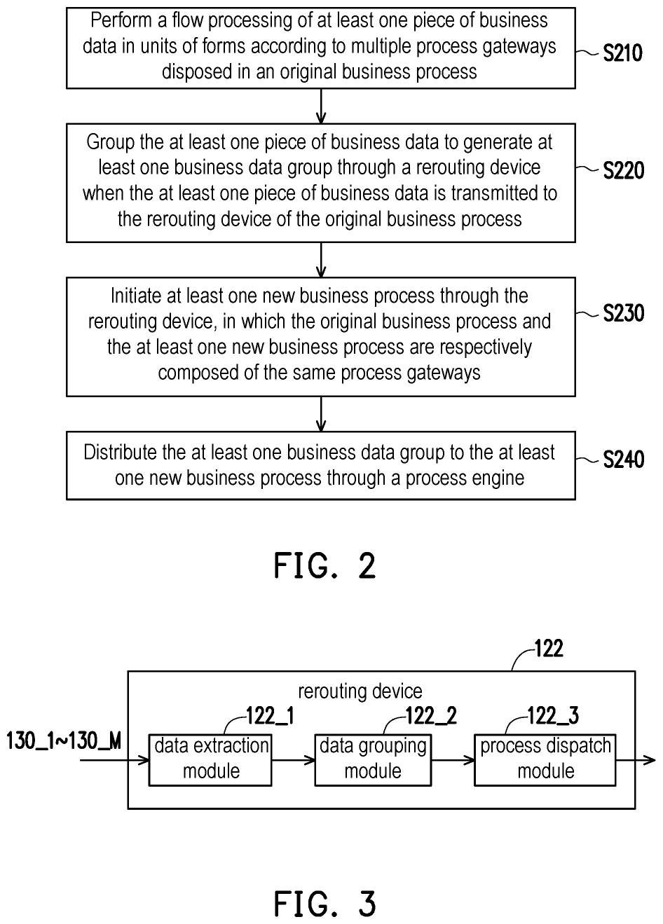

FIG. 2 is a flowchart of a business process management method according to an embodiment of the disclosure. Referring to FIG. 1 and FIG. 2, the business process management system 100 may perform steps S210 to S240 as shown in FIG. 2 to implement the business process management. In this embodiment, users or the business process management system 100 may initiate the original business process 120A that has been designed to be capable of distributing. In step S210, the process engine 110 performs the flow processing of the at least one piece of business data 130_1 to 130_M in units of forms according to the multiple process gateways 121_1 to 121_N disposed in the original business process 120A. In this regard, the at least one piece of business data 130_1 to 130_M transmits in sequence through the multiple process gateways 121_1 to 121_N. In this regard, before the at least one piece of business data 130_1 to 130_M is transmitted to the rerouting device 122, and after the at least one piece of business data 130_1 to 130_M that must be processed by the current process gateway (business behavior) is processed, all the business data 130_1 to 130_M will be transmitted to the next process gateway together. In step S220, when the at least one piece of business data 130_1 to 130_M is transmitted to the rerouting device 122 in the original business process 120A, the rerouting device 122 groups multiple business data to generate at least one business data group. In this embodiment, the rerouting device 122 may, for example, additionally take out the part (business behavior) that the current process gateway does not need to process.

In step S230, the rerouting device 122 may initiate at least one new business process. The original business process 120A and the at least one new business process are respectively composed of the same process gateways 121_1 to 121_N. In step S240, the process engine 110 distributes the at least one business data group to the at least one new business process. In this regard, since generation of the at least one new business process does not require the process engine 110 to additionally analyze the multiple process gateways 121_1 to 121_N, and the at least one new business process initiated by the rerouting device 122 does not affect business behaviors, the business process management system 100 may maintain favorable system operating efficiency.

In addition, the specific implementation of the rerouting device 122 and the new business process will be described in detail by the following embodiments.

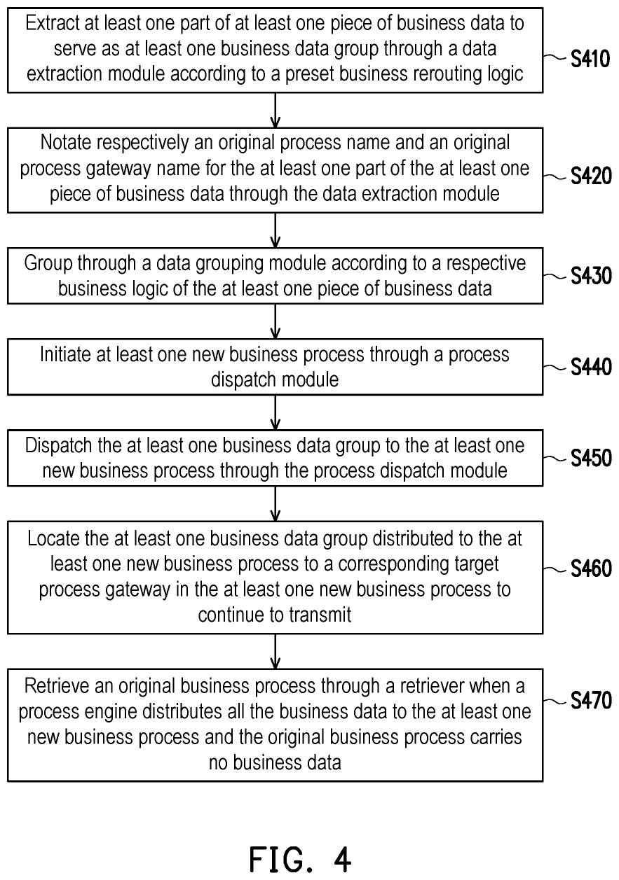

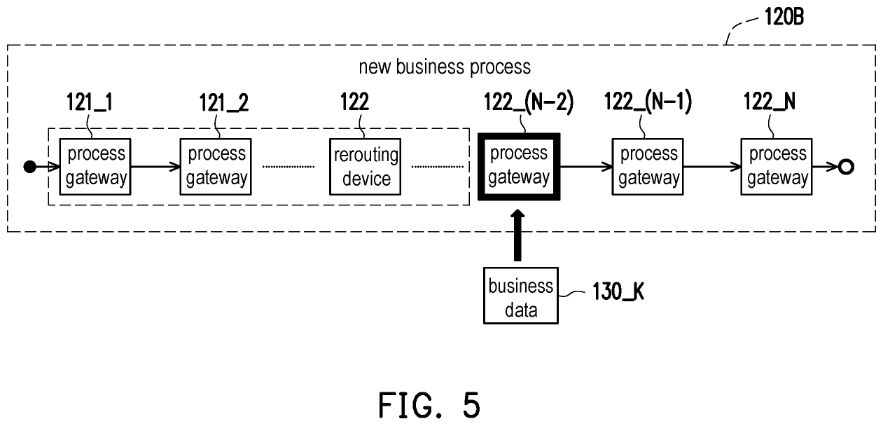

FIG. 3 is a schematic diagram of a rerouting device according to an embodiment of the disclosure. FIG. 4 is a flowchart of a business process management method according to another embodiment of the disclosure. Referring to FIG. 1, FIG. 3, and FIG. 4, in this embodiment, the rerouting device 122 may include a data extraction module 122_1, a data grouping module 122_2, and a process dispatch module 122_3. The data grouping module 122_2 is coupled to the data extraction module 122_1 and the process dispatch module 122_3. The rerouting device 122 may perform the process shown in FIG. 4 to implement distribution operation. In step S410, the data extraction module 122_1 extracts at least one part of the at least one piece of business data 130_1 to 130_M to serve as the at least one business data group according to a preset business rerouting logic. In this embodiment, the data extraction module 122_1 may first define the distribution rules in advance, and extract a part of the at least one piece of business data 130_1 to 130_M that needs to be distributed. In step S420, the data extraction module 122_1 respectively notates an original process name and an original process gateway name and other records for the at least one part of the at least one piece of business data 130_1 to 130_M. In this embodiment, the data extraction module 122_1 may, for example, respectively notates “original process name” and “original process gateway name”, etc. for the at least one part of the at least one piece of business data 130_1 to 130_M. In step S430, the data grouping module 122_2 groups according to a respective business logic (business requirements) of the at least one piece of business data 130_1 to 130_M. In this embodiment, the data grouping module 122_2 may, for example, groups the at least one part of the business data 130_1 to 130_M that has been notated according to the business logic recorded in the respective business data, and further notates records such as “expected gateway name” in the respective business data.

In step S440, the process dispatch module 122_3 initiates the at least one new business process. In this embodiment, the at least one new business process corresponds to a grouping result of the business data 130_1 to 130_M. In other words, the number of new processes is the same as the number of grouping. In step S450, the process dispatch module 122_3 dispatches the at least one business data group to the at least one new business process. In step S460, the locator 111 locates the at least one business data group distributed to the at least one new business process to a corresponding target process gateway in the at least one new business process to continue the transmission.

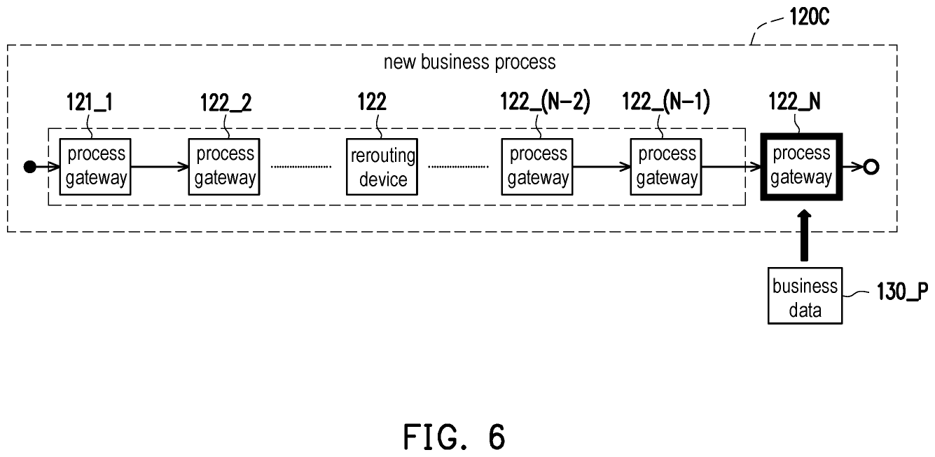

In this regard, referring to FIG. 5 and FIG. 6, FIG. 5 is a schematic diagram of a new business process according to an embodiment of the disclosure. FIG. 6 is a schematic diagram of another new business process according to an embodiment of the disclosure. The process dispatch module 122_3 may initiate, for example, new business processes 120B and 120C as shown in FIG. 5 and FIG. 6. In addition, the data grouping module 122_2 may group business data 130_K and business data 130_P from the business data 130_1 to 130 M, where K and S are respectively positive integers between 1 and M, and the business data 130_K and the business data 130_P may respectively represent different one or more pieces of business data among the business data 130_1 to 130_M. The process dispatch module 122_3 may through the locator 111 of the process engine 110 according to the “original process name”, “original process gateway name” and “expected gateway name” in the records corresponding to the business data 130_K and the business data 130_P, directly dispatch the business data 130_K and the business data 130_P in respective new business processes 120B and 120C to correct target process gateways expected to be performed, for example, a process gateway 122_S and a process gateway 122 N, to continue the business activities until the end of the respective processes. In other words, the business data 130_K and the business data 130_P that has been distributed does not need to be re-sent from the process gateway 122_1 in the new business processes 120B and 120C respectively. Therefore, an efficient business flow may be performed and consumption of system resources may be effectively saved.

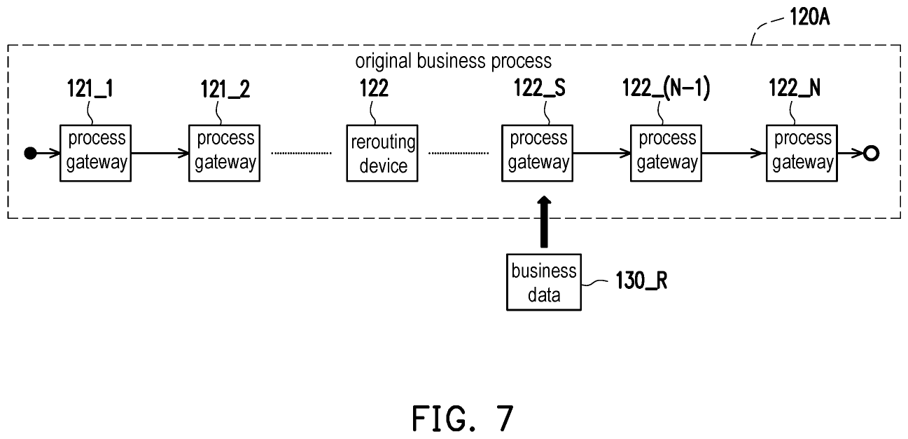

In step S470, when the process engine distributes all the business data to the at least one new business process and the original business process carries no business data, the retriever 112 retrieves the original business process. In this regard, referring to FIG. 7, FIG. 7 is a schematic diagram of the original business process of an embodiment of the disclosure. When the data extraction module 122_1 extracts the business data 130_K and the business data 130_P from the business data 130_1 to 130_M, for a remaining business data 130_R (which may be one or more pieces of business data), the process engine 110 will continue to transmit the remaining service data 130_R to the next process gateway 122_S of the rerouting device 122. However, if the data extraction module 122_1 extracts the business data 130_K and the business data 130_P from the business data 130_1 to 130_M, and the retriever 112 of the process engine 110 detects that there is no remaining business data in the original business process 120A, the retriever 112 retrieves the original business process 120A and suspends the process, so as to effectively save the consumption of system resources.

In summary, the business process management system and the business process management method of the disclosure allow users to decide whether to distribute or not at any gateway according to actual scenario requirements, which may effectively improve work efficiency of users and efficiency of facing application scenarios. In addition, the business process management system and the business process management method of the disclosure may dynamically determine the number of distributions according to actual business requirements, without being fixed due to process design. Moreover, the business process management system and business process management method of the disclosure may initiate new business processes and design of the locator and the retriever without the need for additional analysis of the process gateways, so as to effectively save the consumption of system resources.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A business process management system, comprising:
a process engine, performing a flow processing of at least one piece of business data in units of forms according to a plurality of process gateways disposed in an original business process; and
a rerouting device, disposed in the original business process, wherein when the at least one piece of business data is transmitted to the rerouting device, the rerouting device groups the at least one piece of business data to generate at least one business data group, and initiates at least one new business process,
wherein the original business process and the at least one new business process are respectively composed of the same process gateways,
wherein the process engine distributes the at least one business data group to the at least one new business process.

2. The business process management system according to claim 1, wherein the rerouting device comprises:
a data extraction module, configured to extract at least one part of the at least one piece of business data to serve as the at least one business data group according to a preset business rerouting logic.

3. The business process management system according to claim 2, wherein the data extraction module separately notates an original process name and an original process gateway name for the at least one part of the at least one piece of business data.

4. The business process management system according to claim 3, wherein the rerouting device further comprises:
a data grouping module, coupled to the data extraction module, and configured to group according to a respective business logic of the at least one piece of business data.

5. The business process management system according to claim 4, wherein the rerouting device further comprises:
a process dispatch module, coupled to the data grouping module, and configured to initiate the at least one new business process,
wherein the process dispatch module dispatches the at least one business data group to the at least one new business process.

6. The business process management system according to claim 1, wherein the process engine comprises:
a locator, configured to locate the at least one business data group distributed to the at least one new business process to a corresponding target process gateway in the at least one new business process to continue to transmit.

7. The business process management system according to claim 1, wherein the process engine comprises:
a retriever, configured to retrieve the original business process when the process engine distributes all the business data to the at least one new business process and the original business process carries no business data.

8. The business process management system according to claim 1, wherein the process engine is implemented based on specifications of business process model and notation.

9. The business process management system according to claim 1, wherein the rerouting device is disposed between two of the process gateways in the original business process.

10. The business process management system according to claim 1, wherein the process gateways respectively correspond to different business scenarios.

11. A business process management method, comprising:
performing a flow processing of at least one piece of business data in units of forms according to a plurality of process gateways disposed in an original business process; and
grouping the at least one piece of business data through a rerouting device to generate at least one business data group when the at least one piece of business data is transmitted to the rerouting device;
initiating at least one new business process through the rerouting device, wherein the original business process and the at least one new business process are respectively composed of the same process gateways; and
distributing the at least one business data group to the at least one new business process through the process engine.

12. The business process management method according to claim 11, wherein the step of grouping the at least one piece of business data through the rerouting device to generate the at least one business data group comprises:
extracting at least one part of the at least one piece of business data to serve as the at least one business data group through a data extraction module according to a preset business rerouting logic.

13. The business process management method according to claim 12, wherein the step of grouping the at least one piece of business data through the rerouting device to generate the at least one business data group further comprises:
notating respectively an original process name and an original process gateway name for the at least one part of the at least one piece of business data through the data extraction module.

14. The business process management method according to claim 13, wherein the step of grouping the at least one piece of business data through the rerouting device to generate the at least one business data group further comprises:
grouping through a data grouping module according to a respective business logic of the at least one piece of business data.

15. The business process management method according to claim 14, wherein the step of initiating the at least one new business process through the rerouting device comprises:
initiating the at least one new business process through a process dispatch module; and
dispatching the at least one business data group to the at least one new business process through the process dispatch module.

16. The business process management method according to claim 11, further comprising:
locating the at least one business data group distributed to the at least one new business process to a corresponding target process gateway in the at least one new business process to continue to transmit.

17. The business process management method according to claim 11, further comprising:
retrieving the original business process through a retriever when the process engine distributes all the business data to the at least one new business process and the original business process carries no business data.

18. The business process management method according to claim 11, wherein the process engine is implemented based on specifications of business process model and notation.

19. The business process management method according to claim 11, wherein the rerouting device is disposed between two of the process gateways in the original business process.

20. The business process management method according to claim 11, wherein the process gateways respectively correspond to different business scenarios.
